(19) United States
(12) Patent Application Publication
(10) Pub. No.: US 2012/0070763 A1
(43) Pub. Date: Mar. 22, 2012

(54) CATALYST, PRODUCTION PROCESS THEREFOR AND USE THEREOF

(75) Inventors: Ryuji Monden, Chiba-shi (JP); Takuya Imai, Chiba-shi (JP); Toshikazu Shishikura, Chiba-shi (JP); Yasuaki Wakizaka, Chiba-shi (JP); Kenichiro Ota, Koganei-shi (JP)

(73) Assignee: SHOWA DENKO K.K., Minato-ku, Tokyo (JP)

(21) Appl. No.: 13/319,637

(22) PCT Filed: May 11, 2010
(86) PCT No.: PCT/JP10/57932

§ 371 Date: Nov. 9, 2011

(30) Foreign Application Priority Data
May 11, 2009 (JP) 2009-115039

(51) Int. Cl. H01M 4/90; C07F 7/00; C07F 19/00; H01M 8/10

(52) U.S. Cl. 429/480; 429/523; 556/37; 556/28

(57) ABSTRACT

The invention provides catalysts that are not corroded in acidic electrolytes or at high potential and have excellent durability and high oxygen reducing ability, and processes for producing the catalysts and uses of the catalysts. The catalyst of the invention includes a metal oxycarbonitride that contains at least one metal selected from tantalum, vanadium, molybdenum and zirconium (hereinafter, also referred to as “metal M” or simply “M”) and does not contain any of platinum, titanium and niobium.

### TECHNICAL FIELD

The present invention relates to catalysts, processes for producing the same, and uses of the catalysts. More particularly, the invention relates to fuel cell electrode catalysts, processes for producing the same, and uses of the catalysts.

### BACKGROUND ART

Fuel cells are classified into several types according to the electrolytes or the electrodes used therein. Typical types are alkaline types, phosphoric acid types, molten carbonate types, solid electrolyte types and polymer electrolyte types. In particular, polymer electrolyte fuel cells that can operate at temperatures ranging from low temperatures (about −40° C.) to about 120° C. have attracted attention and have been progressively developed and practically used as low-pollution power sources for automobiles. The polymer electrolyte fuel cells are expected to be used as automobile drive sources or stationary power sources. However, the use in these applications requires long-term durability.

The polymer electrolyte fuel cell has a solid polymer electrolyte sandwiched between an anode and a cathode. A fuel is fed to the anode, and oxygen or air is supplied to the cathode, whereby oxygen is reduced at the cathode to produce electricity. The fuel is usually hydrogen or methanol.

To increase the reaction rate in a fuel cell and enhance the energy conversion efficiency, a layer containing a catalyst (hereinafter, also referred to as “fuel cell catalyst layer”) is conventionally provided on the surface of a cathode (an air electrode) or an anode (a fuel electrode) of a fuel cell.

Here, noble metals are generally used as the catalysts. Of the noble metals, platinum that is stable at high potential and has high activity is most frequently used. However, since platinum is expensive and exists in a limited amount, alternative catalysts have been desired.

Further, the noble metals used on the cathode surface are often dissolved in an acidic atmosphere and are not suited in applications requiring long-term durability. Accordingly, it has been strongly demanded that catalysts be developed which are not corroded in an acidic atmosphere and have excellent durability and high oxygen reducing ability.

Materials containing nonmetals such as carbon, nitrogen and boron have captured attention as alternative catalysts to platinum. The materials containing these nonmetals are inexpensive compared to the noble metals such as platinum and are abundant. Thus, the application of the materials into various fields has been studied in universities and research institutes.

For example, Patent Literature 1 discloses an oxycarbonitride obtained by mixing a carbide, an oxide and a nitride and heating the mixture in vacuum or an inert or non-oxidative atmosphere at 500 to 1500° C. However, the oxycarbonitride disclosed in Patent Literature 1 is a thin-film magnetic head ceramic substrate material, and the use of the oxycarbonitride as catalyst is not considered therein.

Patent Literature 2 discloses, as platinum-alternative materials, oxygen-reducing electrode materials containing a nitride of one or more elements selected from Groups 4, 5 and 14 in the long periodic table. However, the materials containing these nonmetals do not show sufficient oxygen reducing ability for practical use as catalysts.

Patent Literature 3 discloses, as platinum-alternative materials, oxygen-reducing electrode materials containing a carbonitride of one or more elements selected from Group 5 elements except vanadium, Group 4 elements except titanium and Group 6 elements. However, the materials containing these nonmetals do not have sufficient oxygen reducing ability for practical use as catalysts.

Further, Nonpatent Literature 1 discloses a method of forming tantalum oxynitride on glassy carbon by sputtering metallic tantalum in a mixture gas of argon, oxygen and nitrogen. Nonpatent Literature 1 studies TaNO as a fuel cell oxygen reduction catalyst. However, this compound is not tantalum oxycarbonitride, and the production method is not an oxidation method using hydrogen gas.

### CITATION LIST

### Patent Literatures

Patent Literature 1: JP-A-2003-342058
Patent Literature 2: JP-A-2007-31781
Patent Literature 3: JP-A-2008-108594 Nonpatent Literature
Nonpatent Literature 1: Akimitsu Ishihara, Shotaro Doia, Shigenori Mitsushima and Ken-ichiro Ota 1, “Electrochemica Acta”, vol. 53, issue 16, 30 June, 2008, pp. 5442-5450

### SUMMARY OF INVENTION

### Technical Problem

The present invention is aimed at solving the problems in the background art described above. It is therefore an object of the invention to provide catalysts that are not corroded in acidic electrolytes or at high potential and have excellent durability and high oxygen reducing ability.

### Solution to Problem

The present inventors carried out studies to solve the conventional problems in the art. They have then found that a catalyst formed of a metal oxycarbonitride that contains a specific metal and does not contain any of platinum, titanium and niobium shows high oxygen reducing ability. The present invention has been completed based on the finding.

For example, the present invention is concerned with the following (1) to (16).

(1) A catalyst which comprises a metal oxycarbonitride that contains at least one metal selected from the group consisting of tantalum, vanadium, molybdenum and zirconium (hereinafter, also referred to as “metal M” or simply “M”) and does not contain any of platinum, titanium and niobium.

(2) The catalyst described in (1), wherein the metal oxycarbonitride is represented by the compositional formula MCₓN_{y}O_{z} (wherein x, y and z represent a ratio of the numbers of the atoms, 0.01≦x≦2, 0.01≦y≦2, 0.01≦z≦3, and x+y+z≦5).

(3) The catalyst described in (1), wherein the metal oxycarbonitride contains a metal (hereinafter, also referred to as “metal M1” or simply “M1”) other than the metal M, platinum, titanium and niobium, and

the metal oxycarbonitride is represented by the compositional formula MM1ₐCₓN_{y}O_{z} (wherein a, x, y and z represent a ratio of the numbers of the atoms, 0.0001≦a≦1.0, 0.01≦x≦2, 0.01≦y≦2, 0.01≦z≦3, and x+y+z≦5).

(4) The catalyst described in any one of (1) to (3), wherein the metal M is zirconium and the metal oxycarbonitride shows an X-ray diffraction peak at a diffraction angle 2θ in the range of 27.5° to 32.5° in powder X-ray diffractometry (Cu-Kα radiation).

(5) The catalyst described in any one of (1) to (4), which is a fuel cell catalyst.

(6) A process for producing the catalyst described in any one of (1) to (5), comprising:

a step (step 1) of heating a compound that contains at least one metal selected from the group consisting of tantalum, vanadium, molybdenum and zirconium (hereinafter, also referred to as “metal M” or simply “M”) in the presence of carbon atoms in nitrogen gas or a nitrogen compound-containing gas, thereby producing a metal carbonitride; and

a step (step 2) of heating the metal carbonitride in an oxygen-containing inert gas to produce the metal oxycarbonitride.

(7) The process described in (6), wherein the heating in the step (step 1) is performed at a temperature in the range of 600 to 2200° C.

(8) The process described in (6) or (7), wherein the heating in the step (step 2) is performed at a temperature in the range of 400 to 1400° C.

(9) The process described in anyone of (6) to (8), wherein the inert gas in the step (step 2) has an oxygen gas concentration in the range of 0.1 to 10% by volume.

(10) The process described in any one of (6) to (9), wherein the inert gas in the step (step 2) contains hydrogen gas and the hydrogen gas concentration is in the range of 0.01 to 10% by volume.

(11) A fuel cell catalyst layer comprising the catalyst described in any one of (1) to (5).

(12) The fuel cell catalyst layer described in (11), which further comprises an electron conductive substance.

(13) An electrode comprising a fuel cell catalyst layer and a porous support layer, wherein the fuel cell catalyst layer is the fuel cell catalyst layer described in (11) or (12).

(14) A membrane electrode assembly comprising a cathode, an anode and an electrolyte membrane interposed between the cathode and the anode, wherein the cathode and/or the anode is the electrode described in (13).

(15) A fuel cell comprising the membrane electrode assembly described in (14).

(16) A polymer electrolyte fuel cell comprising the membrane electrode assembly described in (14).

### Advantageous Effects of Invention

The catalysts according to the invention are stable and are not corroded in acidic electrolytes or at high potential, have high oxygen reducing ability and are inexpensive because, in particular, the catalysts do not contain platinum. The fuel cells having the catalysts are therefore relatively inexpensive and have high performance.

### BRIEF DESCRIPTION OF DRAWINGS

FIG. 1 is a powder X-ray diffraction spectrum of a metal carbonitride (1) in Example 1.

FIG. 2 is a powder X-ray diffraction spectrum of a catalyst (1) in Example 1.

FIG. 3 is a graph showing an evaluation of the oxygen reducing ability of a fuel cell electrode (1) in Example 1.

FIG. 4 is a powder X-ray diffraction spectrum of a catalyst (2) in Example 2.

FIG. 5 is a graph showing an evaluation of the oxygen reducing ability of a fuel cell electrode (2) in Example 2.

FIG. 6 is a powder X-ray diffraction spectrum of a catalyst (3) in Example 3.

FIG. 7 is a graph showing an evaluation of the oxygen reducing ability of a fuel cell electrode (3) in Example 3.

FIG. 8 is a powder X-ray diffraction spectrum of a catalyst (4) in Example 4.

FIG. 9 is a graph showing an evaluation of the oxygen reducing ability of a fuel cell electrode (4) in Example 4.

FIG. 10 is a powder X-ray diffraction spectrum of a catalyst (5) in Example 5.

FIG. 11 is a graph showing an evaluation of the oxygen reducing ability of a fuel cell electrode (5) in Example 5.

FIG. 12 is a powder X-ray diffraction spectrum of a metal carbonitride (6) in Example 6.

FIG. 13 is a powder X-ray diffraction spectrum of a catalyst (6) in Example 6.

FIG. 14 is a graph showing an evaluation of the oxygen reducing ability of a fuel cell electrode (6) in Example 6.

FIG. 15 is a powder X-ray diffraction spectrum of a metal carbonitride (7) in Example 7.

FIG. 16 is a powder X-ray diffraction spectrum of a catalyst (7) in Example 7.

FIG. 17 is a graph showing an evaluation of the oxygen reducing ability of a fuel cell electrode (7) in Example 7.

FIG. 18 is a powder X-ray diffraction spectrum of a metal carbonitride (8) in Example 8.

FIG. 19 is a powder X-ray diffraction spectrum of a catalyst (8) in Example 8.

FIG. 20 is a graph showing an evaluation of the oxygen reducing ability of a fuel cell electrode (8) in Example 8.

FIG. 21 is a graph showing an evaluation of the oxygen reducing ability of a fuel cell electrode (9) in Example 9.

FIG. 22 is a graph showing an evaluation of the oxygen reducing ability of a fuel cell electrode (10) in Comparative Example 1.

FIG. 23 is a powder X-ray diffraction spectrum of a catalyst (11) in Example 10.

FIG. 24 is a graph showing an evaluation of the oxygen reducing ability of a fuel cell electrode (11) in Example 10.

### DESCRIPTION OF EMBODIMENTS

### Catalysts

A catalyst according to the invention includes a metal oxycarbonitride which contains at least one metal selected from tantalum, zirconium, tin, indium, copper, iron, tungsten, chromium, molybdenum, hafnium, vanadium, cobalt, manganese, gold, silver, iridium, palladium, yttrium, ruthenium, nickel and rare earth metals, and which does not contain any of platinum, titanium and niobium.

In particular, the catalyst preferably contains at least one metal selected from tantalum, vanadium, molybdenum and zirconium (hereinafter, also referred to as “metal M” or simply “M”). Such a catalyst achieves higher catalytic performance.

From the viewpoint of catalytic performance, it is also preferable that the catalyst contain in addition to the metal M a metal (hereinafter, also referred to as “metal M1” or simply “M1”) other than the metal M, platinum, titanium and niobium.

Herein, the rare earth metals are selected from the group including lanthanum, cerium, praseodymium, neodymium, promethium, samarium, europium, gadolinium, terbium, dysprosium, holmium, erbium, thulium, ytterbium and lutetium, and are preferably selected from lanthanum, cerium, neodymium, samarium and europium.

The words such as “does not contain” or “free of” mean that the substance(s) that follows these words is not detected when the catalyst of the invention is analyzed by, for example, elemental analysis. However, these words do not expel the presence of such substances in impurity amounts. The term impurity amounts refers to cases where the catalyst of the invention contains, for example, platinum, titanium and niobium in 1/1000 mol or less based on (1 mol of) the metal M.

The catalyst of the invention may contain two or more kinds of metals as long as the metals are other than platinum, titanium and niobium. In such cases, it is not necessary that all the metals form oxycarbonitride.

The crystalline components in the metal oxycarbonitride of the present invention are considered to have at least an oxide crystal structure. However, it is conceivable that the metal and oxygen are present as a crystalline compound, namely, as an oxide possibly having an oxygen vacancy, and carbon and nitrogen are present as an amorphous compound. That is, the metal oxycarbonitride is possibly a mixture of several compounds. It is, however, difficult to separate and identify these compounds.

Because the catalyst of the invention is possibly a mixture as described above, it is difficult to determine the proportions of carbon, nitrogen and oxygen that are contained in each of the metal oxycarbonitrides, the crystalline oxides and the amorphous carbon/nitrogen compounds. However, it is preferable that the whole metal oxycarbonitride be represented by the compositional formula MCₓN_{y}O_{z} (wherein M is the metal that has been added, x, y and z represent a ratio of the numbers of the atoms, 0.01≦x≦2, 0.01≦y≦2, 0.01≦z≦3, and x+y+z≦5).

In the above compositional formula, it is more preferable that 0.02≦2, 0.01≦y≦2, 0.04≦z≦3, and 0.07≦x+y+z≦5.

The ratio of the numbers of the atoms in the above ranges is preferable in that the oxygen reduction potential tends to be increased.

When the catalyst contains the metal M1, the whole metal oxycarbonitride is preferably represented by the compositional formula MM1ₐCₓN_{y}O_{z} (wherein a, x, y and z represent a ratio of the numbers of the atoms, 0.0001≦a≦1.0, 0.01≦2, 0.01≦y≦2, 0.01≦z≦3, and x+y+z 5).

In the above compositional formula, it is more preferable that 0.0002 a 0.5, 0.01≦2, 0.01≦y≦2, 0.04≦z≦3, and 0.07≦x+y+z≦5.

When the metal M is zirconium, the oxycarbonitride thereof shows an X-ray diffraction peak at a diffraction angle 2θ in the range of 27.5° to 32.5° in powder X-ray diffractometry (Cu-Kα radiation). This peak is probably assigned to a structure such as ZrO₂ (monoclinic, orthorhombic), ZrO₂ (tetragonal) or ZrO_{1.99} (tetragonal). In particular, an X-ray diffraction peak observed at a diffraction angle 2θ in the range of 29° to 31° is probably assigned to a structure such as ZrO₂ (tetragonal) or ZrO_{1.99} (tetragonal).

In this case, it is considered that the tetragonal skeleton of zirconium oxide represents a large proportion in the zirconium-containing oxycarbonitride. The present inventors assume that the catalyst of the invention achieves higher oxygen reducing ability because of a large proportion of the tetragonal zirconium oxide skeleton in the zirconium-containing oxycarbonitride.

Here, the X-ray diffraction peak refers to a peak that is observed at a specific diffraction angle and a specific diffraction intensity when a sample (crystal) is irradiated with X-rays at various angles. In the invention, a signal that is detected with a signal (S) to noise (N) ratio (S/N) of 2 or more is regarded as an X-ray diffraction peak. Here, the noise (N) is the width of the baseline. The X-ray diffraction intensity I is defined to be read from the baseline.

For example, the X-ray diffractometer may be powder X-ray diffractometer X′Pert PRO manufactured by PANalytical. The measurement conditions may be X-ray output: 45 kV, 40 mA, scan axis: 2θ/θ, measurement angles (2θ): 10° to 89.98°, scan size: 0.017°, scan step time: 10.3 sec, scan type: continuous, PSD mode: scanning, divergence slit (DS) type: fixed, irradiation width: 10 mm, measurement temperature: 25° C., target: Cu, K-Alpha 1: 1.54060, K-Alpha 2:1.54443, K-Beta: 1.39225, K-A2/K-A1 ratio:0.5, and goniometer radius: 240 mm.

The catalyst according to the present invention is particularly preferable as a fuel cell catalyst.

The catalyst in the invention preferably has an oxygen reduction onset potential of not less than 0.5 V as measured versus a reversible hydrogen electrode (vs. NHE) by the measurement method (A) described below.

### [Measurement Method (A)]

The catalyst and carbon as the electron conductive substance are added to a solvent, and the mixture is ultrasonically stirred to give a suspension in which the catalyst dispersed on the carbon accounts for 1% by mass. The carbon herein is carbon black (specific surface area: 100-300 m²/g) (e.g., XC-72 manufactured by Cabot Corporation), and the catalyst is dispersed thereon with a catalyst:carbon mass ratio of 95:5. The solvent is a mixture of isopropyl alcohol:water=2:1 (by mass).

While ultrasonicating the suspension, a 10 μl portion thereof is collected and is quickly dropped onto a glassy carbon electrode (diameter: 5.2 mm) and dried at 120° C. for 5 minutes to form a fuel cell catalyst layer containing the catalyst on the glassy carbon electrode. The dropping and drying operations are repeated until at least 1.0 mg of the fuel cell catalyst layer is formed on the carbon electrode surface.

Subsequently, 10 μl of NAFION (registered trademark) (a 5% NAFION (registered trademark) solution (DE521) manufactured by Du Pont Kabushiki Kaisha) diluted ten times with pure water is dropped onto the fuel cell catalyst layer and is dried at 120° C. for 1 hour.

The electrode manufactured above is polarized in a 0.5 mol/dm³ sulfuric acid solution at 30° C. under an oxygen atmosphere or a nitrogen atmosphere at a potential scanning rate of 5 mV/sec, thereby recording a current-potential curve. As a reference, a reversible hydrogen electrode is polarized in a sulfuric acid solution of the same concentration. In the current-potential curve, the potential at which the reduction current starts to differ by 0.2 μA/cm² or more between the polarization under the oxygen atmosphere and that under the nitrogen atmosphere is obtained as the oxygen reduction onset potential.

If the oxygen reduction onset potential is less than 0.7 V (vs. NHE), the use of the catalyst in a fuel cell cathode may cause the generation of hydrogen peroxide. For favorable oxygen reduction, the oxygen reduction onset potential is preferably 0.85 V (vs. NHE) or above. A higher oxygen reduction onset potential is more preferable. The upper limit of the oxygen reduction onset potential is not particularly limited but is theoretically 1.23 V (vs. NHE).

The fuel cell catalyst layer according to the invention that is prepared using the inventive catalyst is preferably used in an acidic electrolyte at a potential of not less than 0.4 V (vs. NHE). The upper limit of the potential depends on the stability of the electrode. The electrode according to the invention may be used at as high a potential as about 1.23 V (vs. NHE) which is the oxygen generation potential.

At a potential of less than 0.4 V (vs. NHE), the compound can exist stably but oxygen cannot be reduced favorably. Catalyst layers having such a low potential are not useful as fuel cell catalyst layers used in membrane electrode assemblies for fuel cells.

### (Catalyst Production Processes)

The above-described catalysts may be produced by any processes without limitation. An exemplary process includes a step of heating a metal carbonitride containing at least one metal M selected from tantalum, vanadium, molybdenum and zirconium in an inert gas containing oxygen gas, thereby producing a metal oxycarbonitride containing the metal M.

The metal carbonitride is preferably obtained by heating a compound containing the metal (s) M in the presence of carbon atoms in nitrogen gas or a nitrogen compound-containing gas (step 1).

Steps performed in the production process will be described below.

### (Step 1: Step of Producing Metal Carbonitride)

In the step 1, a compound containing the metal(s) M is heated in the presence of carbon atoms in nitrogen gas or a nitrogen compound-containing gas to give a metal carbonitride.

The step 1 is carried out in the presence of carbon atoms. The carbon atoms may be contained in the compound containing the metal M, or a simple substance of carbon or a carbon-containing compound other than the metal M-containing compound may be used in the step 1. In particular, it is preferable to use one or more metal M-containing compounds including at least a metal M-containing compound which further contains carbon atoms, or to use a simple substance of carbon, or to use both a metal M-containing compound which further contains carbon atoms, and a simple substance of carbon.

In the production of the metal carbonitride, the heating temperature is in the range of 600 to 2200° C., and preferably 800 to 2000° C.

This heating temperature is preferable in that high crystallinity and homogeneity are obtained. Heating at temperatures below 600° C. tends to result in deteriorations in crystallinity and homogeneity. Heating at temperatures above 2200° C. tends to result in excessive sintering and crystal growth. Nitrogen for the synthesis of the carbonitride may be supplied to the reaction by feeding nitrogen gas or a nitrogen compound-containing gas.

Examples of the metal M-containing compounds as materials include oxides, carbides, nitrides, carbonates, nitrates, carboxylates such as acetates, oxalates and citrates, and phosphates.

Examples of the oxides include tantalum oxide, vanadium oxide, molybdenum oxide, zirconium oxide and zirconium oxychloride.

Examples of the carbides include tantalum carbide, vanadium carbide, molybdenum carbide and zirconium carbide.

Examples of the nitrides include tantalum nitride, vanadium nitride, molybdenum nitride and zirconium nitride.

Examples of the carbonates include tantalum carbonate, vanadium carbonate, molybdenum carbonate and zirconium carbonate.

The number of the metal M-containing compounds that are used is not particularly limited. That is, one or more metal M-containing compounds may be used.

It is a preferred embodiment to use one or more metal M-containing compounds including at least a metal M oxide.

The step 1 may further involve a compound containing a metal M1 in addition to the metal M-containing compound. The metal M1 is preferably at least one metal selected from tin, indium, copper, iron, tungsten, chromium, hafnium, cobalt, manganese, gold, silver, iridium, palladium, yttrium, ruthenium, nickel and rare earth metals. Examples of the metal M1-containing compounds include organic acid salts, nitrates, carbonates, phosphates, chlorides, organic complexes, oxides, carbides and nitrides of the metals M1.

In the case where the metal M1-containing compound is used in the step 1, the usage amount thereof is usually such that the amount of the metal M1 of the metal M1-containing compound is 0.0001 to 1 mol, and preferably 0.0002 to 0.5 mol based on 1 mol of the metal M of the metal M-containing compound.

The use of the metal M1-containing compound in the step 1 results in the inventive metal oxycarbonitride that has the metal M1.

Carbon (simple substance of carbon) may be added separately when the metal M-containing compound that is a material in the step 1 does not contain carbon as well as when the metal M-containing compound contains carbon.

Examples of the carbons (simple substances of carbon) include carbon, carbon blacks, graphites, black leads, activated carbons, carbon nanotubes, carbon nanofibers, carbon nanohorns and fullerenes. The carbons preferably have smaller particle diameters. Such carbon particles have a larger specific surface area and react easily with the oxides. A suitable carbon material is carbon black (specific surface area: 100-300 m²/g, for example XC-72 manufactured by Cabot Corporation).

It is preferable to perform the heating in nitrogen gas or a nitrogen compound-containing gas irrespective of whether the metal M-containing compound that is a material in the step 1 contains nitrogen or does not contain nitrogen.

Needless to mention, the addition of carbon and nitrogen is not compulsory depending on the metal M-containing compound that is a material in the step 1.

### (Step 2: Step of Producing Metal Oxycarbonitride)

Next, there will be described a step of heating the metal carbonitride from the (step 1) in an inert gas containing oxygen gas to produce the metal oxycarbonitride.

The “inert gas containing oxygen gas” will be otherwise referred to as the “oxygen-containing inert gas”.

Examples of the inert gases include nitrogen gas, helium gas, neon gas, argon gas, krypton gas, xenon gas and radon gas. Nitrogen gas and argon gas are particularly preferable because of their relatively easy availability.

In this step, the concentration of oxygen gas in the inert gas depends on the heating time and the heating temperature, but is preferably 0.1 to 10% by volume, and particularly preferably 0.5 to 5% by volume with respect to the total gas volume. This oxygen gas concentration is preferable in that a homogeneous oxycarbonitride is obtained. If the oxygen gas concentration is less than 0.1% by volume, the oxidation tends to fail. If the concentration is in excess of 10% by volume, the oxidation tends to proceed excessively.

In the (step 2), it is preferable to add hydrogen gas to the oxygen-containing inert gas in order to control oxidation. The concentration of the hydrogen gas that is added depends on the heating time and the heating temperature, but is preferably 0.01 to 10% by volume, and particularly preferably 0.1 to 5% by volume with respect to the total gas volume. This hydrogen gas concentration is preferable in that a homogeneous oxycarbonitride is obtained. A hydrogen gas concentration in excess of 10% by volume tends to result in excessive reduction.

In this step (step 2), the heating is usually performed at a temperature in the range of 400 to 1400° C., and preferably 600 to 1200° C. This heating temperature is preferable in that a homogeneous metal oxycarbonitride is obtained. If the heating temperature is below 400° C., the oxidation tends not to proceed. Heating at a temperature above 1400° C. tends to result in excessive oxidation and crystal growth.

The heating methods in this step (step 2) include common methods such as a stationary method and a stirring method, as well as a dropping method and a powder capturing method.

In the dropping method, an induction furnace is heated to the predetermined heating temperature while passing the inert gas containing the trace amount of oxygen gas through the furnace; a thermal equilibrium is maintained at the temperature and the metal carbonitride is dropped and heated in a crucible which is the heating zone in the furnace. The dropping method is advantageous in that the aggregation and growth of particles of the metal carbonitride are minimized.

In the dropping method, the heating time for the metal carbonitride is usually from 0.5 to 10 minutes, and preferably from 1.0 to 3 minutes. This heating time is preferable in that a homogeneous metal oxycarbonitride tends to be obtained. Heating for less than 0.5 minutes tends to result in partial formation of the metal oxycarbonitride. If the heating time exceeds 10 minutes, the oxidation tends to proceed excessively.

In the powder capturing method, the metal carbonitride is caused to suspend as particles in the inert gas atmosphere containing the trace amount of oxygen gas, and the metal carbonitride is captured and heated in a vertical tubular furnace controlled at the predetermined heating temperature.

In the powder capturing method, the heating time for the metal carbonitride is from 0.2 seconds to 1 minute, and preferably from 0.5 to 10 seconds. This heating time is preferable in that a homogeneous metal oxycarbonitride tends to be obtained. Heating for less than 0.2 seconds tends to result in partial formation of the metal oxycarbonitride. If the heating time exceeds 1 minute, the oxidation tends to proceed excessively. When the heating is performed in a tubular furnace, the heating time for the metal carbonitride may be from 0.1 to 10 hours, and preferably from 0.5 to 5 hours. This heating time is preferable in that a homogeneous metal oxycarbonitride tends to be obtained. Heating for less than 0.1 hours tends to result in partial formation of the metal oxycarbonitride. If the heating time exceeds 10 hours, the oxidation tends to proceed excessively.

In the invention, the metal oxycarbonitride obtained by any of the aforementioned processes may be used directly as the catalyst according to the invention. In another embodiment, the metal oxycarbonitride may be crushed into finer particles.

The methods for crushing the metal oxycarbonitride include roll milling, ball milling, medium stirring milling, and crushing with an air flow crusher, a mortar or a crushing tank. To crush the metal oxycarbonitride into finer particles, an air flow crusher is preferably used. To facilitate the crushing in small amounts, the use of a mortar is preferable.

### <Uses>

The catalysts according to the present invention may be used as alternative catalysts to platinum catalysts.

For example, the catalysts of the invention may be used as fuel cell catalysts, exhaust gas treatment catalysts and organic synthesis catalysts.

A fuel cell catalyst layer according to the invention contains the above catalyst.

A fuel cell catalyst layer is either an anode catalyst layer or a cathode catalyst layer. The fuel cell catalyst layer of the invention may be used as both of an anode catalyst layer and a cathode catalyst layer.

Because the fuel cell catalyst layer of the invention contains the catalyst that has high oxygen reducing ability and is resistant to corrosion in an acidic electrolyte even at high potential, it is particularly suited as a catalyst layer in a fuel cell cathode (a cathode catalyst layer). In particular, the fuel cell catalyst layer is suitably provided in a cathode of a membrane electrode assembly in a polymer electrolyte fuel cell.

In a preferred embodiment, the fuel cell catalyst layer of the invention further contains an electron conductive substance. When the fuel cell catalyst layer containing the catalyst further contains an electron conductive substance, the reduction current may be further increased. The increase in the reduction current is probably because the electron conductive substance establishes electrical contacts within the catalyst to induce electrochemical reaction.

When the electron conductive substance is in the form of particles, it may be used as a carrier for the catalyst.

Examples of the electron conductive substances include carbons, conductive polymers, conductive ceramics and conductive inorganic oxides (such as tungsten oxide and iridium oxide). These substances may be used singly or in combination with one another.

In particular, because carbon has a large specific surface area, it is preferable to use carbon alone or a mixture of carbon and another electron conductive substance. That is, the fuel cell catalyst layer according to a preferred embodiment contains the catalyst and carbon.

Examples of the carbons include carbon blacks, graphites, black leads, activated carbons, carbon nanotubes, carbon nanofibers, carbon nanohorns and fullerenes.

If the particle diameter of carbon is excessively small, the carbon may not be able to form an electron conductive path. If the particle diameter is excessively large, the fuel cell catalyst layer tends to reduce gas diffusion properties or the catalyst usage rate tends to be lowered. Thus, the carbon particle diameter is preferably in the range of 10 to 1000 nm, and more preferably 20 to 100 nm.

When the electron conductive substance is carbon, the mass ratio of the catalyst and the carbon (catalyst:carbon) is preferably in the range of 4:1 to 1000:1.

The conductive polymers are not particularly limited. Examples thereof include polyacetylene, poly-p-phenylene, polyaniline, polyalkylaniline, polypyrrole, polythiophene, polyindole, poly-1,5-diaminoanthraquinone, polyaminodiphenyl, poly(o-phenylenediamine), poly(quinolinium) salt, polypyridine, polyquinoxaline and polyphenylquinoxaline. Of these, polypyrrole, polyaniline and polythiophene are preferred, and polypyrrole is more preferred.

Preferably, the fuel cell catalyst layer of the invention further contains a polymer electrolyte.

The polymer electrolytes are not particularly limited as long as they are commonly used in fuel cell catalyst layers. Specific examples include perfluorocarbon polymers having a sulfonic acid group (such as NAFION (registered trademark) (a 5% NAFION (registered trademark) solution (DE521) manufactured by Du Pont Kabushiki Kaisha), hydrocarbon polymer compounds having a sulfonic acid group, polymer compounds doped with inorganic acids such as phosphoric acid, organic/inorganic hybrid polymers partially substituted with proton conductive functional groups, and proton conductors composed of a polymer matrix impregnated with a phosphoric acid solution or a sulfuric acid solution. Of these, NAFION (registered trademark) (a 5% NAFION (registered trademark) solution (DE521) manufactured by Du Pont Kabushiki Kaisha) is preferable.

The catalyst may be dispersed on the carrier by methods such as in-liquid dispersion methods and airborne dispersion methods. The in-liquid dispersion methods are preferable because the dispersion of the catalyst and the carrier in a solvent can be used in the production of the fuel cell catalyst layer.

Exemplary in-liquid dispersion methods include an orifice-choked flow method, a rotational shear flow method and an ultrasonic method. The solvents used in the in-liquid dispersion methods are not particularly limited as long as the catalyst and the electron conductive substance are not corroded and are dispersed therein. Volatile liquid organic solvents and water are generally used.

When the catalyst is dispersed on the electron conductive substance, the polymer electrolyte described above and a dispersant may be dispersed together therewith.

The fuel cell catalyst layer may be formed by any methods without limitation. For example, a suspension containing the catalyst, the electron conductive substance and the polymer electrolyte may be applied to an electrolyte membrane or a gas diffusion layer described later.

The application methods include dipping, screen printing, roll coating and spraying. In another embodiment, a suspension containing the catalyst, the electron conductive substance and the polymer electrolyte may be applied or filtered onto a substrate to form a fuel cell catalyst layer, and the catalyst layer may be transferred to an electrolyte membrane.

An electrode according to the present invention contains the fuel cell catalyst layer and a porous support layer.

The porous support layer is a layer which diffuses gas (hereinafter, also referred to as “gas diffusion layer”). The gas diffusion layers are not particularly limited as long as they have electron conductivity, high gas diffusion properties and high corrosion resistance. Carbon-based porous materials such as carbon paper and carbon cloth, and stainless steel and anticorrosive-coated aluminum foils for weight reduction may be generally used.

A membrane electrode assembly of the invention has a cathode, an anode and an electrolyte membrane between the cathode and the anode. The cathode and/or the anode is the electrode described hereinabove.

The electrolyte membranes may be general perfluorosulfonic acid electrolyte membranes or hydrocarbon electrolyte membranes. Further, polymer fine-pore membranes impregnated with liquid electrolyte, or porous membranes filled with polymer electrolyte may be used.

A fuel cell according to the present invention has the membrane electrode assembly described above.

The electrode reaction in a fuel cell takes place at a three-phase interface (electrolyte-electrode catalyst-reaction gas). Fuel cells are classified according to the used electrolytes into several types such as molten carbonate fuel cells (MCFC), phosphoric acid fuel cells (PAFC), solid oxide fuel cells (SOFC) and polymer electrolyte fuel cells (PEFC). In particular, the membrane electrode assembly of the invention may be preferably used in a polymer electrolyte fuel cell.

### EXAMPLES

The present invention will be described in greater detail by presenting examples hereinbelow without limiting the scope of the invention.

In Examples and Comparative Examples, measurements were carried out by the following methods.

### [Analytical Methods]

### 1. Powder X-ray Diffractometry

Samples were analyzed by powder X-ray diffractometry using X'Pert PRO manufactured by PANalytical.

In the powder X-ray diffractometry of each sample, the number of X-ray diffraction peaks was counted in a manner such that a signal which was detected with a signal (S) to noise (N) ratio (S/N) of 2 or more was regarded as a diffraction peak. The noise (N) was the width of the baseline.

### 2. Elemental Analysis

Carbon: Approximately 0.1 g of a sample was weighed out and analyzed with EMIA-110 manufactured by HORIBA, Ltd.

Nitrogen and oxygen: Approximately 0.1 g of a sample sealed in a Ni cup was analyzed with an ON analyzer.

Metals: Approximately 0.1 g of a sample was weighed on a platinum dish, and a nitric acid-hydrofluoric acid mixture was added thereto. The sample was then thermally decomposed. The thermal decomposition product was collected to a predetermined volume, diluted and analyzed with ICP-MS.

### Example 1

### 1. Preparation of Catalyst

Zirconium carbide weighing 8.34 g (81 mmol), zirconium oxide weighing 1.23 g (10 mmol) and zirconium nitride weighing 0.53 g (5 mmol) were sufficiently crushed and mixed together. The resultant powder mixture was heated in a tubular furnace in a nitrogen atmosphere at 1800° C. for 3 hours to give 8.85 g of a metal carbonitride (1). Since this metal carbonitride (1) had been sintered, it was crushed in a mortar.

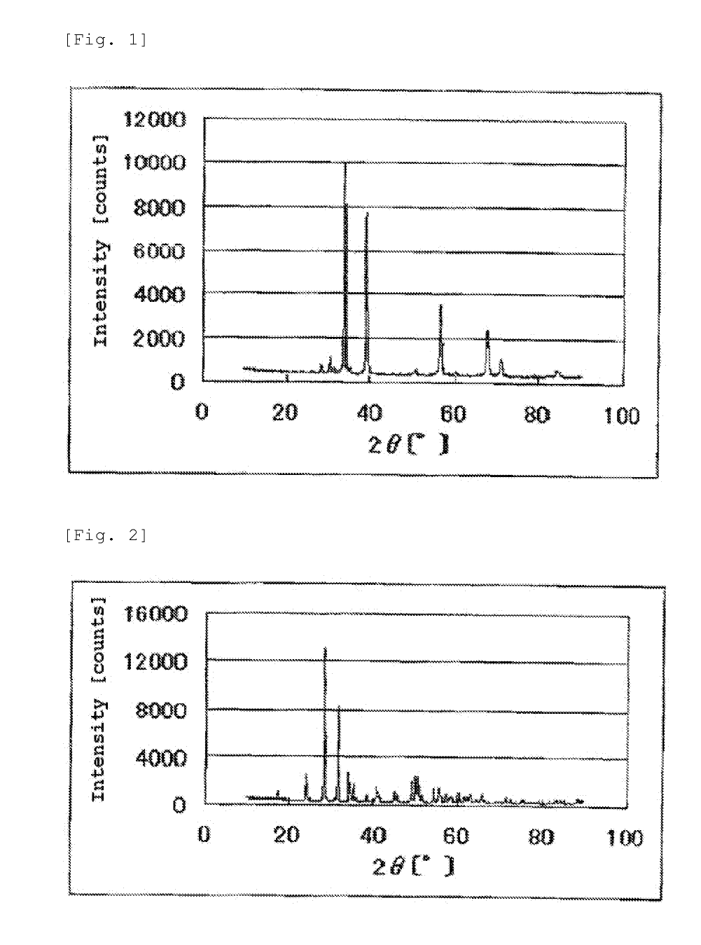

A powder X-ray diffraction spectrum of the metal carbonitride (1) is shown in FIG. 1. The results of the elemental analysis of the metal carbonitride (1) are described in Table 1.

Subsequently, 1.0 g of the metal carbonitride (1) was heated in a stationary electric furnace at 900° C. for 8 hours while passing nitrogen gas containing 1% by volume of oxygen gas and 1% by volume of hydrogen gas. As a result, a metal-containing oxycarbonitride (hereinafter, also referred to as “catalyst (1)”) was prepared.

A powder X-ray diffraction spectrum of the catalyst (1) is shown in FIG. 2. In the powder X-ray diffraction spectrum, the X-ray diffraction peak observed at a diffraction angle 2θ of 29° to 31° is probably assigned to a structure such as ZrO₂ (tetragonal) or ZrO_{1.99} (tetragonal). The results of the elemental analysis of the catalyst (1) are described in Table 2.

### 2. Production of Fuel Cell Electrode

The oxygen reducing ability was determined in the following manner. The catalyst (1) in an amount of 0.025 g and carbon (XC-72 manufactured by Cabot Corporation) weighing 0.00125 g were added to 2.5 g of a solution consisting of isopropyl alcohol:pure water=1:1 by mass. The mixture was ultrasonically stirred to give a suspended mixture. The mixture in a volume of 10 μl was applied onto a glassy carbon electrode (diameter: 5.2 mm, manufactured by Tokai Carbon Co., Ltd.) and was dried. These operations were repeated until 2 mg of a catalyst layer was formed on the electrode. Subsequently, 10 μl of NAFION (registered trademark) (a 5% NAFION (registered trademark) solution (DE521) manufactured by Du Pont Kabushiki Kaisha) diluted ten times with isopropyl alcohol was applied thereon and was dried at 60° C. for 1 hour. A fuel cell electrode (1) was thus manufactured.

### 3. Evaluation of Oxygen Reducing Ability

The fuel cell electrode (1) manufactured above was evaluated for catalytic performance (oxygen reducing ability) as described below.

The fuel cell electrode (1) was polarized in a 0.5 mol/dm³ sulfuric acid solution at 30° C. under an oxygen atmosphere or a nitrogen atmosphere at a potential scanning rate of 5 mV/sec, thereby recording a current-potential curve. As a reference, a reversible hydrogen electrode was polarized in a sulfuric acid solution of the same concentration.

In the current-potential curve obtained, the potential at which the reduction current started to differ by 0.2 μA/cm² or more between the polarization under the oxygen atmosphere and that under the nitrogen atmosphere was obtained as the oxygen reduction onset potential. The difference between the reduction currents was obtained as the oxygen reduction current.

The oxygen reducing ability of the fuel cell electrode (1) was evaluated based on the oxygen reduction onset potential and the oxygen reduction current. The higher the oxygen reduction onset potential and the higher the oxygen reduction current, the higher the oxygen reducing ability of the fuel cell electrode (1).

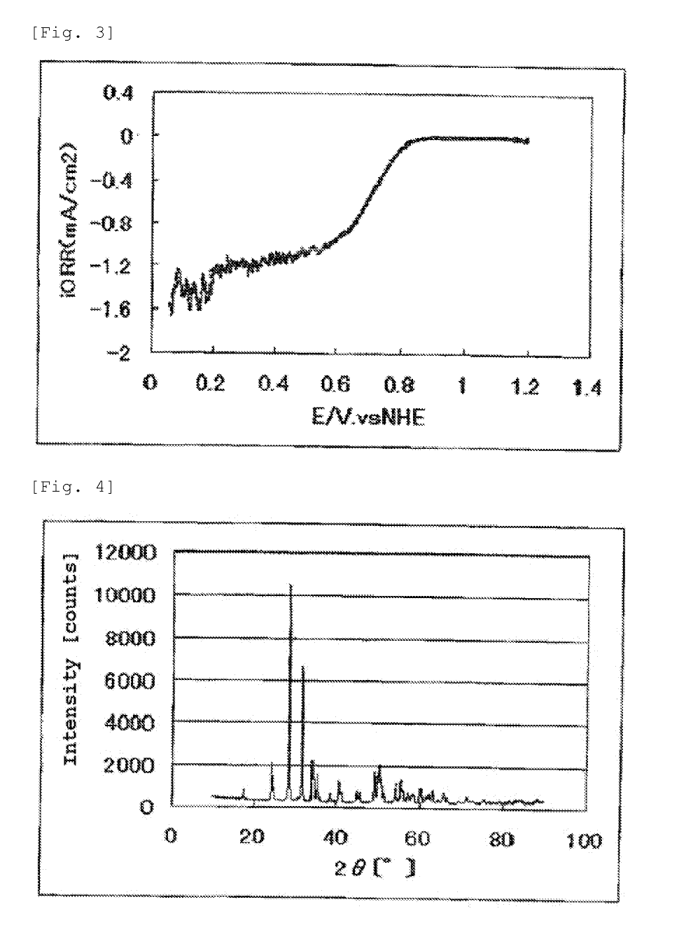

The current-potential curve recorded during the above measurement is shown in FIG. 3.

The fuel cell electrode (1) manufactured in Example 1 had an oxygen reduction onset potential of 0.93 V (vs. NHE) and was found to have high oxygen reducing ability.

### Example 2

### 1. Preparation of Catalyst

A metal carbonitride (1) was prepared in the same manner as in Example 1. Subsequently, 1.00 g of the metal carbonitride (1) was heated in a stationary electric furnace at 1200° C. for 6 hours while passing nitrogen gas containing 1% by volume of oxygen gas and 1% by volume of hydrogen gas. As a result, a metal-containing oxycarbonitride (hereinafter, also referred to as “catalyst (2)”) was prepared.

A powder X-ray diffraction spectrum of the catalyst (2) is shown in FIG. 4. In the powder X-ray diffraction spectrum, the X-ray diffraction peak observed at a diffraction angle 2θ of 27.5° to 32.5° is probably assigned to a structure such as ZrO₂ (tetragonal, monoclinic, orthorhombic) or ZrO_{1.99} (tetragonal). The results of the elemental analysis of the catalyst (2) are described in Table 2.

### 2. Production of Fuel Cell Electrode

A fuel cell electrode (2) was manufactured in the same manner as in Example 1, except that the catalyst (2) was used.

### 3. Evaluation of Oxygen Reducing Ability

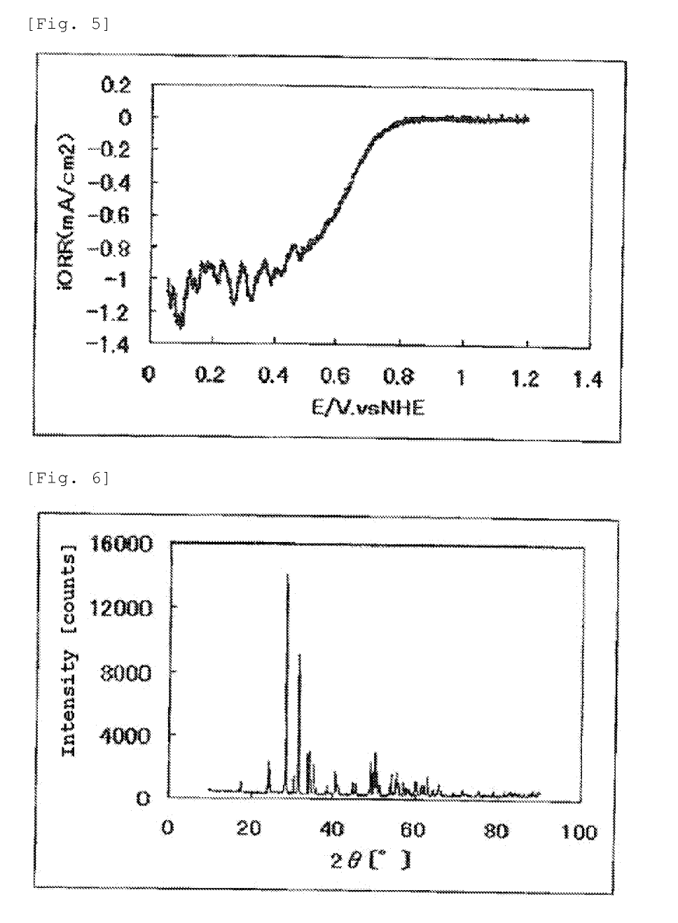

The oxygen reducing ability was evaluated in the same manner as in Example 1, except that the fuel cell electrode (2) was used. The current-potential curve recorded during the measurement is shown in FIG. 5.

The fuel cell electrode (2) manufactured in Example 2 had an oxygen reduction onset potential of 0.90 V (vs. NHE) and was found to have high oxygen reducing ability.

### Example 3

### 1. Preparation of Catalyst

A metal carbonitride (1) was prepared in the same manner as in Example 1. Subsequently, 1.00 g of the metal carbonitride (1) was heated in a rotary kiln at 1200° C. for 12 hours while passing nitrogen gas containing 1% by volume of oxygen gas and 2% by volume of hydrogen gas. As a result, a metal-containing oxycarbonitride (hereinafter, also referred to as “catalyst (3)”) was prepared.

A powder X-ray diffraction spectrum of the catalyst (3) is shown in FIG. 6. In the powder X-ray diffraction spectrum, the X-ray diffraction peak observed at a diffraction angle 2θ of 27.5° to 32.5° is probably assigned to a structure such as ZrO₂ (tetragonal, monoclinic, orthorhombic) or ZrO_{1.99} (tetragonal).

### 2. Production of Fuel Cell Electrode

A fuel cell electrode (3) was manufactured in the same manner as in Example 1, except that the catalyst (3) was used.

### 3. Evaluation of Oxygen Reducing Ability

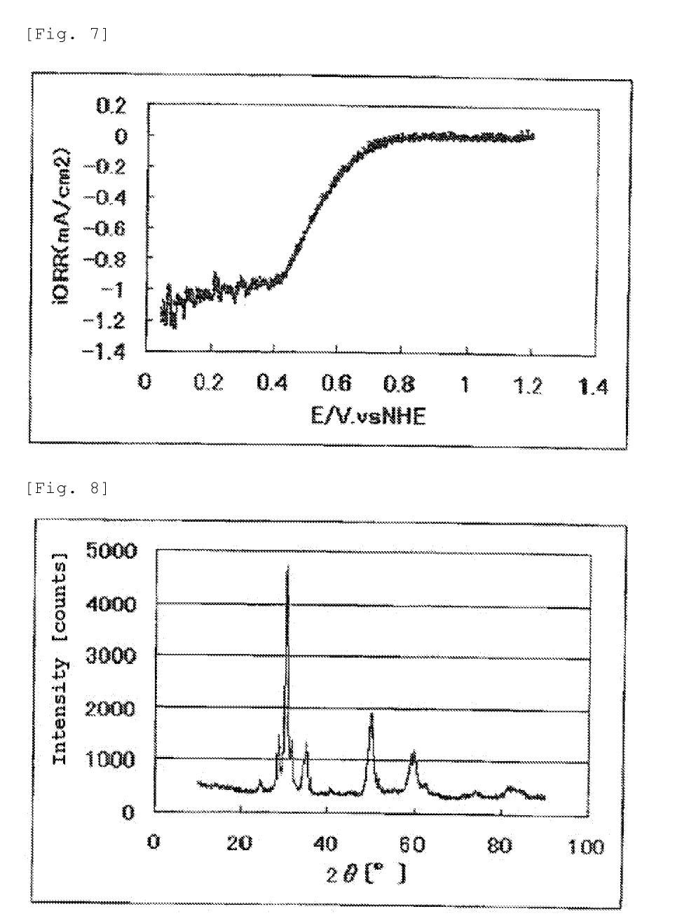

The oxygen reducing ability was evaluated in the same manner as in Example 1, except that the fuel cell electrode (3) was used. The current-potential curve recorded during the measurement is shown in FIG. 7.

The fuel cell electrode (3) manufactured in Example 3 had an oxygen reduction onset potential of 0.85 V (vs. NHE) and was found to have high oxygen reducing ability.

### Example 4

### 1. Preparation of Catalyst

A metal carbonitride (1) was prepared in the same manner as in Example 1. Subsequently, 0.50 g of the metal carbonitride (1) was heated in a rotary kiln at 900° C. for 8 hours while passing equal amounts of argon gas containing 0.5% by volume of oxygen gas and nitrogen gas containing 2% by volume of hydrogen gas. As a result, a metal-containing oxycarbonitride (hereinafter, also referred to as “catalyst (4)”) was prepared.

A powder X-ray diffraction spectrum of the catalyst (4) is shown in FIG. 8. In the powder X-ray diffraction spectrum, the X-ray diffraction peak observed at a diffraction angle 2θ of 27.5° to 32.5° is probably assigned to a structure such as ZrO₂ (tetragonal, monoclinic, orthorhombic) or ZrO_{1.99} (tetragonal).

### 2. Production of Fuel Cell Electrode

A fuel cell electrode (4) was manufactured in the same manner as in Example 1, except that the catalyst (4) was used.

### 3. Evaluation of Oxygen Reducing Ability

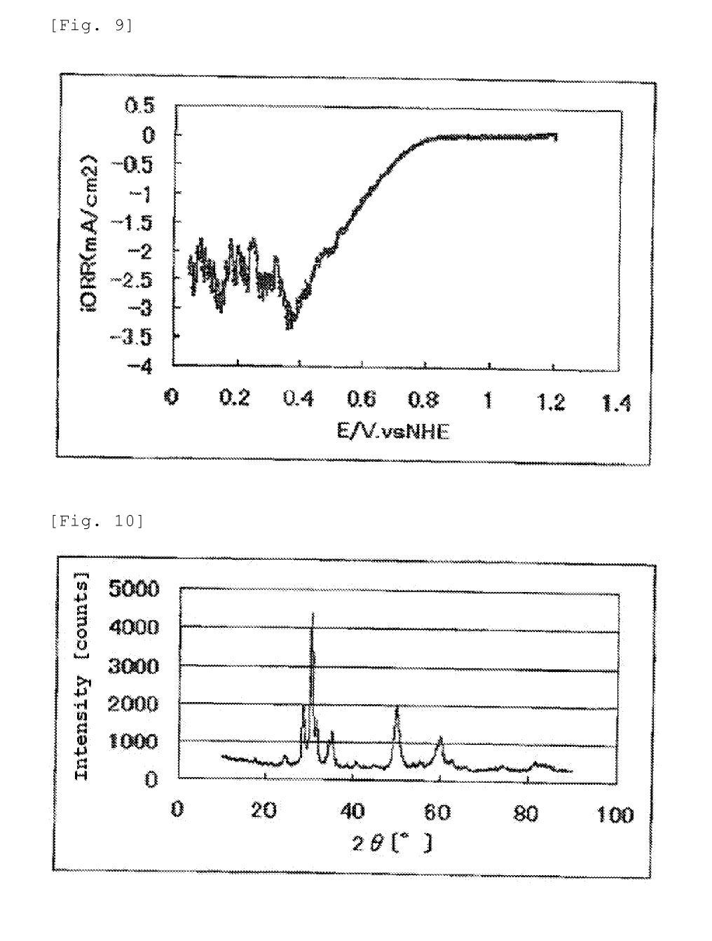

The oxygen reducing ability was evaluated in the same manner as in Example 1, except that the fuel cell electrode (4) was used. The current-potential curve recorded during the measurement is shown in FIG. 9.

The fuel cell electrode (4) manufactured in Example 4 had an oxygen reduction onset potential of 0.90 V (vs. NHE) and was found to have high oxygen reducing ability.

### Example 5

### 1. Preparation of Catalyst

A metal carbonitride (1) was prepared in the same manner as in Example 1. Subsequently, 0.50 g of the metal carbonitride (1) was heated in a rotary kiln at 900° C. for 48 hours while passing equal amounts of argon gas containing 1% by volume of oxygen gas and nitrogen gas containing 4% by volume of hydrogen gas. As a result, a metal-containing oxycarbonitride (hereinafter, also referred to as “catalyst (5)”) was prepared.

A powder X-ray diffraction spectrum of the catalyst (5) is shown in FIG. 10. In the powder X-ray diffraction spectrum, the X-ray diffraction peak observed at a diffraction angle 2θ of 27.5° to 32.5° is probably assigned to a structure such as ZrO₂ (tetragonal, monoclinic, orthorhombic) or ZrO_{1.99} (tetragonal).

### 2. Production of Fuel Cell Electrode

A fuel cell electrode (5) was manufactured in the same manner as in Example 1, except that the catalyst (5) was used.

### 3. Evaluation of Oxygen Reducing Ability

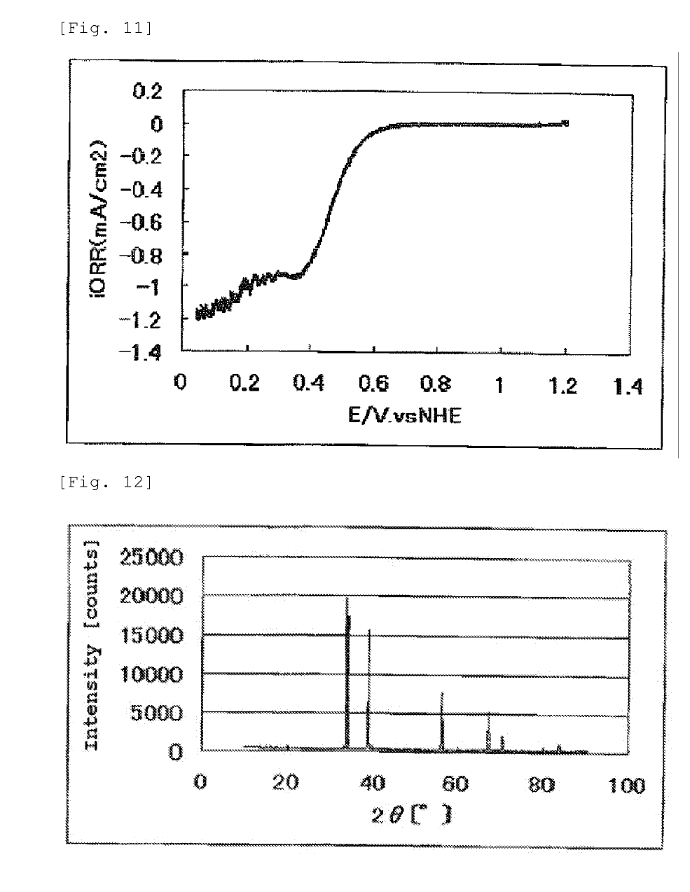

The oxygen reducing ability was evaluated in the same manner as in Example 1, except that the fuel cell electrode (5) was used. The current-potential curve recorded during the measurement is shown in FIG. 11.

The fuel cell electrode (5) manufactured in Example 5 had an oxygen reduction onset potential of 0.85 V (vs. NHE).

### Example 6

### 1. Preparation of Catalyst

Zirconium oxychloride weighing 6.44 g (20 mmol) was dissolved in 10 ml of ethanol and 30 ml of distilled water to give a solution. Further, 600 mg (50 mmol) of carbon (XC-72) was added, followed by stirring for 30 minutes. The solvent was removed under reduced pressure. The resultant powder was heated in a rotary kiln furnace at 1600° C. for 3 hours in a nitrogen atmosphere. As a result, 3.17 g of a metal carbonitride (6) was obtained. The metal carbonitride (6) was crushed in a mortar.

A powder X-ray diffraction spectrum of the metal carbonitride (6) is shown in FIG. 12.

Subsequently, 0.50 g of the metal carbonitride (6) was heated in a rotary kiln at 900° C. for 8 hours while passing equal amounts of argon gas containing 0.5% by volume of oxygen gas and nitrogen gas containing 2% by volume of hydrogen gas. As a result, a metal-containing oxycarbonitride (hereinafter, also referred to as “catalyst (6)”) was prepared.

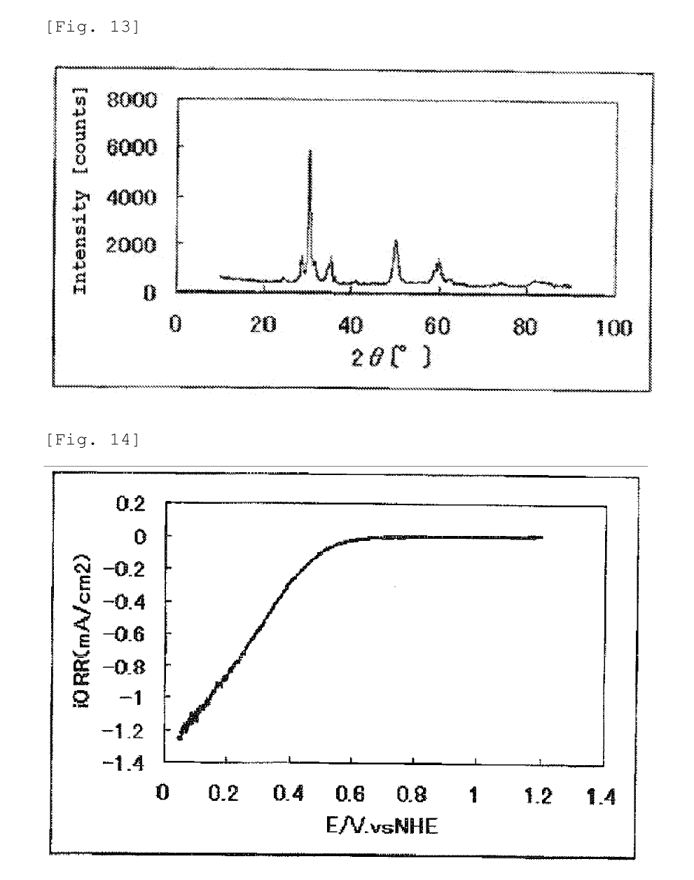

A powder X-ray diffraction spectrum of the catalyst (6) is shown in FIG. 13. In the powder X-ray diffraction spectrum, the X-ray diffraction peak observed at a diffraction angle 2θ of 27.5° to 32.5° is probably assigned to a structure such as ZrO₂ (tetragonal, monoclinic, orthorhombic) or ZrO_{1.99} (tetragonal).

### 2. Production of Fuel Cell Electrode

A fuel cell electrode (6) was manufactured in the same manner as in Example 1, except that the catalyst (6) was used.

### 3. Evaluation of Oxygen Reducing Ability

The oxygen reducing ability was evaluated in the same manner as in Example 1, except that the fuel cell electrode (6) was used. The current-potential curve recorded during the measurement is shown in FIG. 14.

The fuel cell electrode (6) manufactured in Example 6 had an oxygen reduction onset potential of 0.90 V (vs. NHE).

### Example 7

### 1. Preparation of Catalyst

Tantalum carbide weighing 7.91 g (41 mmol), tantalum oxide weighing 1.11 g (2.5 mmol) and tantalum nitride weighing 0.49 g (2.5 mmol) were sufficiently crushed and mixed together. The resultant powder mixture was heated in a tubular furnace in a nitrogen atmosphere at 1800° C. for 3 hours to give 8.79 g of a metal carbonitride (7). Since this metal carbonitride (7) had been sintered, it was crushed in a mortar.

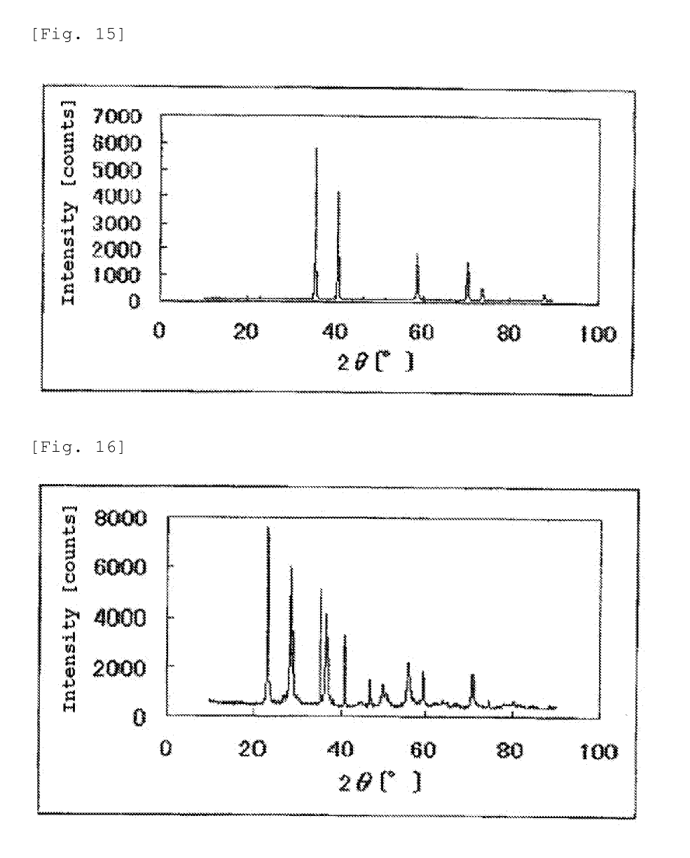

A powder X-ray diffraction spectrum of the metal carbonitride (7) is shown in FIG. 15. The results of the elemental analysis of the metal carbonitride (7) are described in Table 1.

Subsequently, 1.0 g of the metal carbonitride (7) was heated in a rotary kiln at 900° C. for 8 hours while passing nitrogen gas containing 0.5% by volume of oxygen gas and 2% by volume of hydrogen gas. As a result, a metal-containing oxycarbonitride (hereinafter, also referred to as “catalyst (7)”) was prepared.

A powder X-ray diffraction spectrum of the catalyst (7) is shown in FIG. 16. The results of the elemental analysis of the catalyst (7) are described in Table 2.

### 2. Production of Fuel Cell Electrode

A fuel cell electrode (7) was manufactured in the same manner as in Example 1, except that the catalyst (7) was used.

### 3. Evaluation of Oxygen Reducing Ability

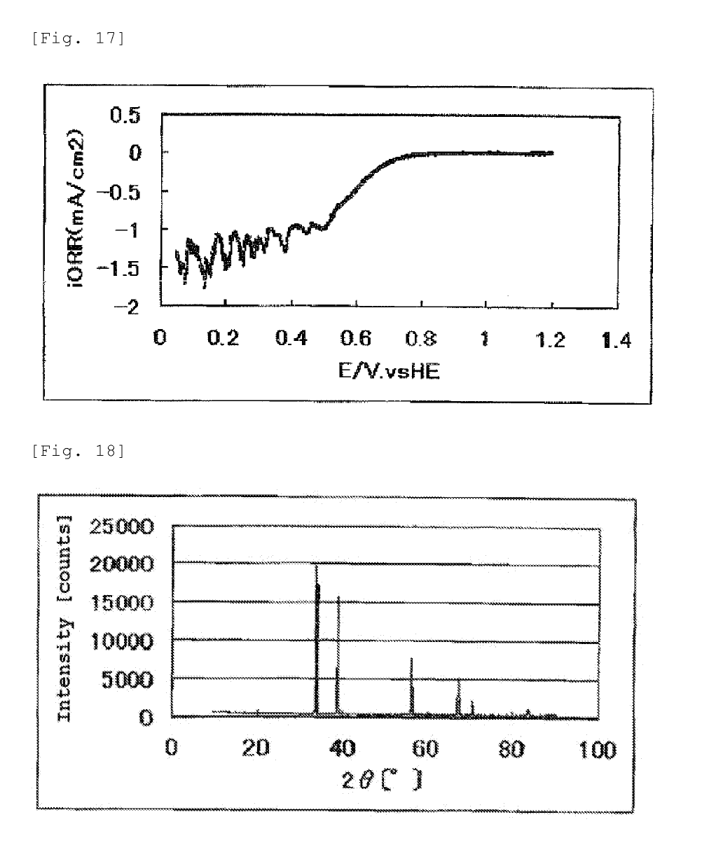

The oxygen reducing ability was evaluated in the same manner as in Example 1, except that the fuel cell electrode (7) was used. The current-potential curve recorded during the measurement is shown in FIG. 17.

The fuel cell electrode (7) manufactured in Example 7 had an oxygen reduction onset potential of 0.90 V (vs. NHE) and was found to have high oxygen reducing ability.

### Example 8

### 1. Preparation of Catalyst

Vanadium carbide weighing 5.10 g (81 mmol), vanadium oxide weighing 0.83 g (10 mmol) and vanadium nitride weighing 0.33 g (5 mmol) were sufficiently crushed and mixed together. The resultant powder mixture was heated in a tubular furnace in a nitrogen atmosphere at 1100° C. for 3 hours to give 4.90 g of a metal carbonitride (8). Since this metal carbonitride (8) had been sintered, it was crushed in a mortar.

A powder X-ray diffraction spectrum of the metal carbonitride (8) is shown in FIG. 18. The results of the elemental analysis of the metal carbonitride (8) are described in Table 1.

Subsequently, 1.0 g of the metal carbonitride (8) was heated in a stationary electric furnace at 900° C. for 8 hours while passing nitrogen gas containing 1% by volume of oxygen gas and 1% by volume of hydrogen gas. As a result, a metal-containing oxycarbonitride (hereinafter, also referred to as “catalyst (8)”) was prepared.

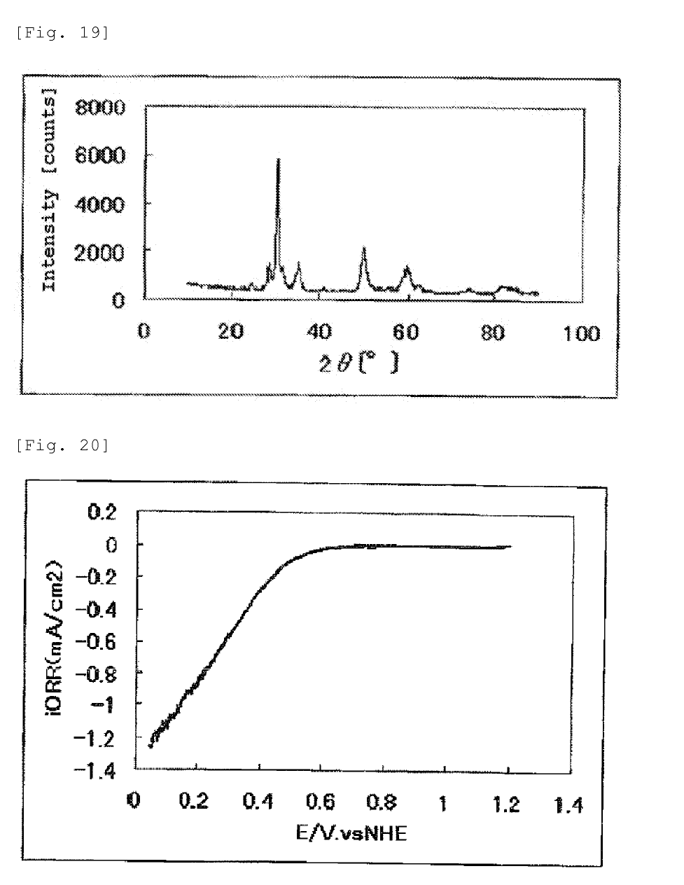

A powder X-ray diffraction spectrum of the catalyst (8) is shown in FIG. 19. The results of the elemental analysis of the catalyst (8) are described in Table 2.

### 2. Production of Fuel Cell Electrode

A fuel cell electrode (8) was manufactured in the same manner as in Example 1, except that the catalyst (8) was used.

### 3. Evaluation of Oxygen Reducing Ability

The oxygen reducing ability was evaluated in the same manner as in Example 1, except that the fuel cell electrode (8) was used. The current-potential curve recorded during the measurement is shown in FIG. 20.

The fuel cell electrode (8) manufactured in Example 8 had an oxygen reduction onset potential of 0.83 V (vs. NHE) and was found to have high oxygen reducing ability.

### Example 9

### 1. Preparation of Catalyst

Molybdenum oxide weighing 7.68 g (60 mmol) and carbon weighing 1.80 g (150 mmol) were sufficiently crushed and mixed together. The resultant powder mixture was heated in a tubular furnace in a nitrogen atmosphere at 1800° C. for 3 hours to give 5.24 g of a metal carbonitride (9). Since this metal carbonitride (9) had been sintered, it was crushed in a mortar.

Subsequently, 1.0 g of the metal carbonitride (9) was heated in a stationary electric furnace at 900° C. for 8 hours while passing nitrogen gas containing 1% by volume of oxygen gas and 1% by volume of hydrogen gas. As a result, a metal-containing oxycarbonitride (hereinafter, also referred to as “catalyst (9)”) was prepared.

### 2. Production of Fuel Cell Electrode

A fuel cell electrode (9) was manufactured in the same manner as in Example 1, except that the catalyst (9) was used.

### 3. Evaluation of Oxygen Reducing Ability

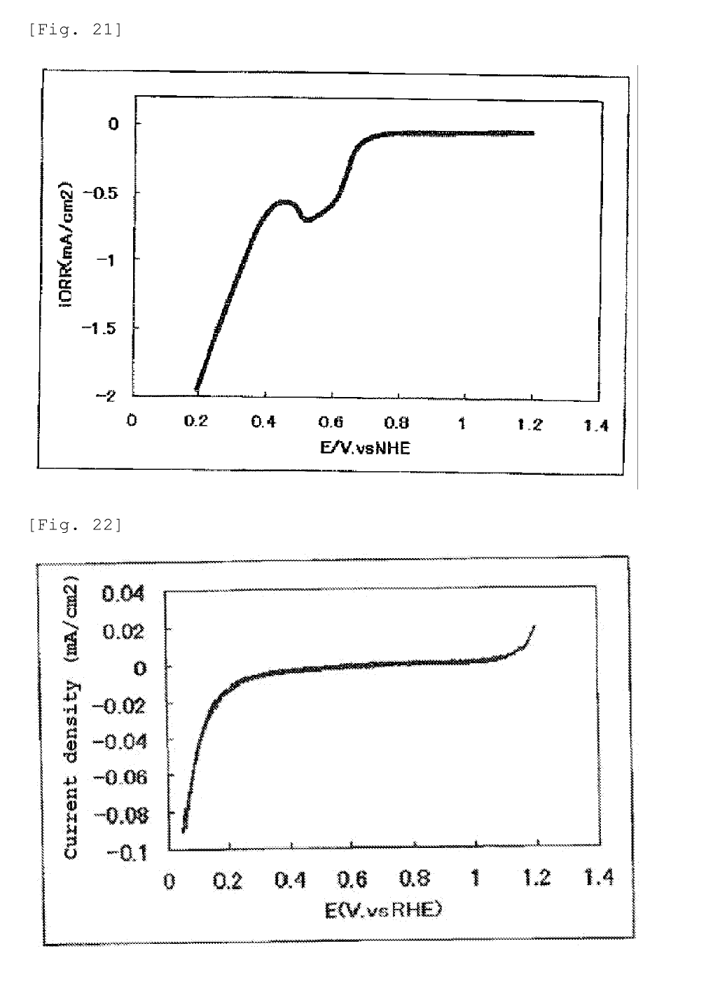

The oxygen reducing ability was evaluated in the same manner as in Example 1, except that the fuel cell electrode (9) was used. The current-potential curve recorded during the measurement is shown in FIG. 21.

The fuel cell electrode (9) manufactured in Example 9 had an oxygen reduction onset potential of 0.70 V (vs. NHE) and was found to have high oxygen reducing ability.

### Comparative Example 1

### 1. Preparation of Catalyst

A metal carbonitride (1) (hereinafter, also referred to as “catalyst (10)”) was prepared in the same manner as in Example 1.

### 2. Production of Fuel Cell Electrode

A fuel cell electrode (10) was manufactured in the same manner as in Example 1, except that the catalyst (10) was used.

### 3. Evaluation of Oxygen Reducing Ability

The oxygen reducing ability was evaluated in the same manner as in Example 1, except that the fuel cell electrode (10) was used. The current-potential curve recorded during the measurement is shown in FIG. 22.

The fuel cell electrode (10) manufactured in Comparative Example 1 had an oxygen reduction onset potential of 0.63 V (vs. NHE) and was found to have low oxygen reducing ability.

### Example 10

### 1. Preparation of Catalyst

A metal carbonitride (1) was prepared in the same manner as in Example 1. Subsequently, 2.08 g (20 mmol) of the metal carbonitride (1) was added to a solution of 404 mg (1 mmol) of ferric nitrate in 20 ml of water, followed by stirring for 30 minutes. Thereafter, water was removed with a freeze dryer. Thus, a metal-supported metal carbonitride (11) was obtained.

Subsequently, 1.00 g of the metal carbonitride (11) was heated in a rotary kiln at 900° C. for 12 hours while passing nitrogen gas containing 1% by volume of oxygen gas and 2% by volume of hydrogen gas. As a result, a metal-containing oxycarbonitride (hereinafter, also referred to as “catalyst (11)”) was prepared.

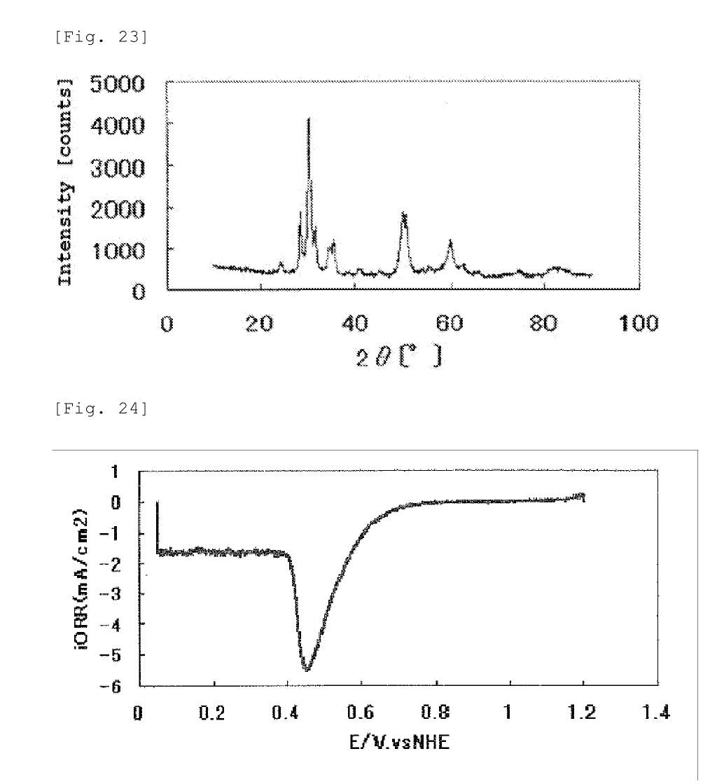

A powder X-ray diffraction spectrum of the catalyst (11) is shown in FIG. 23. In the powder X-ray diffraction spectrum, the X-ray diffraction peak observed at a diffraction angle 2θ of 27.5° to 32.5° is probably assigned to a structure such as ZrO₂ (tetragonal, monoclinic, orthorhombic) or ZrO_{1.99} (tetragonal).

### 2. Production of Fuel Cell Electrode

A fuel cell electrode (11) was manufactured in the same manner as in Example 1, except that the catalyst (11) was used.

### 3. Evaluation of Oxygen Reducing Ability

The oxygen reducing ability was evaluated in the same manner as in Example 1, except that the fuel cell electrode (11) was used. The current-potential curve recorded during the measurement is shown in FIG. 24.

The fuel cell electrode (11) manufactured in Example 10 had an oxygen reduction onset potential of 0.90 V (vs. NHE) and was found to have high oxygen reducing ability.

Elemental analysis: material ZrCN; metals Zr: 71.5 (1), Fe: 2.12 (0.05); C, 2.08 (0.22), N: 0.59 (0.05), O: 23.69 (1.89); compositional formula: ZrFe_{0.05}C_{0.22}N_{0.05}O_{1.89}

### [Table 1]

TABLE 1
Results of elemental analysis of metal carbonitrides (mass % (the
numbers in parenthesis indicate ratios of the numbers of the atoms))

| | | | | | Compositional |
|---|---|---|---|---|---|
| | Materials | Metal | C | N | formula |
| Ex. 1 | ZrC + ZrO₂ + ZrN | Zr: 87.13 | 5.75 | 6.7 | ZrC_{0.50}N_{0.50} |
| | | (1) | (0.50) | (0.50) | |
| Ex. 7 | TaC + TaO₂ + TaN | Ta: 93.01 | 3.21 | 3.45 | TaC_{0.52}N_{0.48} |
| | | (1) | (0.52) | (0.48) | |
| Ex. 8 | VC + VO₂ + VN | V: 79.47 | 9.29 | 10.9 | VC_{0.50}N_{0.50} |
| | | (1) | (0.50) | (0.50) | |

### [Table 2]

TABLE 2
Results of elemental analysis of catalysts (mass % (the numbers
in parenthesis indicate ratios of the numbers of the atoms))

| | | | | | | Compositional |
|---|---|---|---|---|---|---|
| | Material | Metal | C | N | O | formula |
| Ex. 1 | ZrC_{0.50}N_{0.50} | Zr: 73.84 | 1.55 | 0.21 | 24.4 | ZrC_{0.16}N_{0.02}O_{1.88} |
| | | (1) | (0.16) | (0.02) | (1.88) | |
| Ex. 2 | ZrC_{0.50}N_{0.50} | Zr: 73.17 | 1.94 | 0.29 | 24.6 | ZrC_{0.20}N_{0.03}O_{1.92} |
| | | (1) | (0.20) | (0.03) | (1.92) | |
| Ex. 7 | TaC_{0.52}N_{0.48} | Ta: 81.46 | 1.85 | 0.29 | 16.4 | TaC_{0.34}N_{0.05}O_{2.27} |
| | | (1) | (0.34) | (0.05) | (2.27) | |
| Ex. 8 | VC_{0.50}N_{0.50} | V: 59.47 | 5.14 | 2.65 | 32.74 | VC_{0.37}N_{0.16}O_{1.75} |
| | | (1) | (0.37) | (0.16) | (1.75) | |

### INDUSTRIAL APPLICABILITY

The catalysts according to the invention are not corroded in acidic electrolytes or at high potential and have excellent durability and high oxygen reducing ability to find use in fuel cell catalyst layers, electrodes, membrane electrode assemblies and fuel cells.

1. A catalyst which comprises a metal oxycarbonitride that contains at least one metal selected from the group consisting of tantalum, vanadium, molybdenum and zirconium (hereinafter, also referred to as “metal M” or simply “M”) and does not contain any of platinum, titanium and niobium.

2. The catalyst according to claim 1, wherein the metal oxycarbonitride is represented by the compositional formula MCₓN_{y}O_{z} (wherein x, y and z represent a ratio of the numbers of the atoms, 0.01≦2, 0.01≦y≦2, 0.01≦z≦3, and x+y+z≦5).

3. The catalyst according to claim 1, wherein the metal oxycarbonitride contains a metal (hereinafter, also referred to as “metal M1” or simply “M1”) other than the metal M, platinum, titanium and niobium, and
the metal oxycarbonitride is represented by the compositional formula MM1ₐCₓN_{y}O_{z} (wherein a, x, y and z represent a ratio of the numbers of the atoms, 0.0001≦a≦1.0, 0.01≦2, 0.01≦y≦2, 0.01≦z≦3, and x+y+z≦5).

4. The catalyst according to claim 1, wherein the metal M is zirconium and the metal oxycarbonitride shows an X-ray diffraction peak at a diffraction angle 2θ in the range of 27.5° to 32.5° in powder X-ray diffractometry (Cu-Kα radiation).

5. The catalyst according to claim 1, which is a fuel cell catalyst.

6. A process for producing the catalyst described in claim 1, comprising:
a step (step 1) of heating a compound that contains at least one metal selected from the group consisting of tantalum, vanadium, molybdenum and zirconium (hereinafter, also referred to as “metal M” or simply “M”) in the presence of carbon atoms in nitrogen gas or a nitrogen compound-containing gas, thereby producing a metal carbonitride; and
a step (step 2) of heating the metal carbonitride in an oxygen-containing inert gas to produce the metal oxycarbonitride.

7. The process according to claim 6, wherein the heating in the step (step 1) is performed at a temperature in the range of 600 to 2200° C.

8. The process according to claim 6, wherein the heating in the step (step 2) is performed at a temperature in the range of 400 to 1400° C.

9. The process according to claim 6, wherein the inert gas in the step (step 2) has an oxygen gas concentration in the range of 0.1 to 10% by volume.

10. The process according to claim 6, wherein the inert gas in the step (step 2) contains hydrogen gas and the hydrogen gas concentration is in the range of 0.01 to 10% by volume.

11. A fuel cell catalyst layer comprising the catalyst of claim 1.

12. The fuel cell catalyst layer according to claim 11, which further comprises an electron conductive substance.

13. An electrode comprising a fuel cell catalyst layer and a porous support layer, wherein the fuel cell catalyst layer is the fuel cell catalyst layer of claim 11.

14. A membrane electrode assembly comprising a cathode, an anode and an electrolyte membrane interposed between the cathode and the anode, wherein the cathode and/or the anode is the electrode of claim 13.

15. A fuel cell comprising the membrane electrode assembly of claim 14.

16. A polymer electrolyte fuel cell comprising the membrane electrode assembly of claim 14.
